(19) United States
(12) Patent Application Publication
(10) Pub. No.: US 2016/0131618 A1
(43) Pub. Date: May 12, 2016

(54) Separation and Analysis Systems and Methods

(71) Applicant: BLACKTRACE HOLDINGS LIMITED, Royston, Hertfordshire (GB)

(72) Inventor: Albert Koulman, Cambridge (GB)

(21) Appl. No.: 14/896,469

(22) PCT Filed: Nov. 5, 2013
(86) PCT No.: PCT/GB2013/052891

§ 371 Date: Dec. 7, 2015

(30) Foreign Application Priority Data
Jun. 7, 2013 (GB) 1310214.0

(51) Int. Cl. G01N 30/34; G01N 30/72

(52) U.S. Cl. CPC G01N 30/34; G01N 30/7233

(57) ABSTRACT

Disclosed is an extraction and analysis system and method. The system comprises a separation apparatus, a liquid-liquid extraction apparatus and an analysis apparatus. The liquid-liquid extraction apparatus is configured to receive a substantially continuous inlet flow of a first liquid from the separation apparatus, the first liquid carrying a mixture of components including an analyte. The liquid-liquid extraction apparatus is operable to receive a second liquid for contact with the first liquid, the second liquid being substantially immiscible with the first liquid. This provides partitioning of the analyte and/or another component carried by the first liquid preferentially into the second liquid substantially continuously. Subsequently the first and second liquids are separated substantially continuously. The system further comprises an outlet flow conduit operable substantially continuously to conduct the analyte, in a corresponding flow of said first or second liquid, to the analysis apparatus for substantially continuous analysis.

### FIELD OF THE INVENTION

This invention relates to an extraction and analysis system, to a use of the system, and to a method of separating and analysing an analyte from a mixture of components including the analyte. The invention also relates to a separation and extraction system, to a use of the system, and to a method of separating and extracting an analyte from a mixture including the analyte. The invention has particular, but not exclusive, application in the field of investigation of biomolecules.

### RELATED ART

It may be desirable to separate, extract and analyse a quantity or property of a particular analyte that is one of a mixture of components. For example, it may be desirable to analyse a protein or lipid in a blood sample, or other biological sample. In another example, it may be desirable to analyse a polymer in a mixture of polymers.

Techniques are known for substantially separating an analyte from some other components of the mixture containing the analyte. Some of these techniques have a continuous mode of operation; that is, the outflow of the separation technique has a time variance. For example, the concentration and/or nature of the analyte contained in the outflow may vary over time and so the separation technique or outflow does not need to be interrupted in order to obtain fractions containing the analyte. An example of such a technique is chromatography.

It is common for fractions such as those produced by chromatographic techniques to be collected sequentially in separate containers. The point at which a new fraction is collected is commonly decided based on collection over the course of a defined period, or to provide a specified fraction amount e.g. 50 μL or 1 mL. Each separate fraction is therefore a homogeneous solution comprising a multitude of smaller fractions, and therefore contains a concentration of analyte that is the average of each of the smaller fractions. The fractions containing useful and/or measurable amounts of analyte are then selected for further analysis. Sometimes, valuable analyte is therefore lost and not analysed because the homogeneous solution contains too low a concentration for detection or analysis, or because it contains too high a concentration of other material. In some cases, there may be only a small amount of e.g. eluent between the analyte and another component. In such cases, identifying the point at which the analyte stops being eluted and the other component starts being eluted (or vice versa) can be difficult. Therefore, there is a risk that one or more fractions will be contaminated with unwanted component, and for these fractions to not be used subsequently and the analyte lost as a consequence.

Many techniques are known for analysing analytes. Some of these techniques can carry out the analysis substantially continuously. An example is mass spectrometry (MS). MS is typically carried out on charged analytes. A number of mechanisms are known for ionising analytes. Examples include electrospray ionisation (ESI), atmospheric pressure ionisation (API) or atmospheric pressure chemical ionisation (APCI).

It is known that separation and analysis techniques can be used to investigate analytes from a mixture containing the analyte. The use of mass spectrometry in particular allows the determination of not only the different levels of lipoproteins but also the lipid composition of the lipoprotein particles. For example, it is known to use ESI MS to determine lipid compositions from lipoproteins collected by ultra-centrifugation (Hyotylainen T. et al., Molecular BioSystems 2012, 8:2559; Hammad S. M. et al., Journal of Lipid Research 2010, 51:3074-87) or from size-exclusion chromatography (Wiesner P. et al., Journal of Lipid Research 2009, 50:574-85; Scherer M, et al., Biochimica et Biophysica Acta 2011, 1811:68-75).

The presence of non-volatile buffers used during separation can lead to problems during analysis. When the separation is dependent on maintaining the conformation of the analytes (e.g. lipoproteins, proteins or protein complexes), non-volatile buffers are usually essential because volatile buffers do not have the same ionic and osmotic strength. Non-volatile buffers are commonly used in chromatography. Therefore, the analyte-containing fractions are often mixtures including, for example, dissolved salts. Typically the analyte-containing fractions are prepared for analysis in a separate step. For lipid analysis, this is a manual liquid-liquid extraction of each fraction that would result in an organic extract that could be subjected to further analysis such as liquid chromatography-tandem mass spectrometry (LC-MS/MS) or direct infusion mass spectrometry (DIMS) (Wiesner P. et al., Journal of Lipid Research 2009, 50:574-85; Scherer M, et al., Biochimica et Biophysica Acta 2011, 1811:68-75). If pooling of fractions and therefore increased amounts of unwanted components is to be avoided, this step is carried out on each separate fraction. There is an increased risk of loss of analyte during this step, for example due to spillage, which can negatively impact the accuracy of the results obtained, especially in cases where the analyte concentration in the fraction is already low. Further, this approach is time-consuming and can lead to poor resolution. Fractions that are collected and have undergone an extraction step have been used subsequently in proteomic (Dernick G, et al., Journal of Lipid Research 2011, 52:2323-31) and lipidomic approaches (Wiesner P. et al. Journal of Lipid Research 2009, 50:574-85).

As an alternative to non-volatile buffers, volatile buffers have been used in the chromatography stage (Schmidt A. et al., Journal of Mass Spectrometry 2009, 44: 898-910). Such an approach is not suitable for some applications, such as with lipoproteins, especially when the separation is dependent on the specific salt concentration of the buffer, which may be the case with SEC.

Separation or detection of different lipoprotein classes is possible using, for example, ultra-centrifugation, differential precipitation (Warnick G. et al., Lab Medicine 2008, 39:481-490) and electrophoresis (März W. et al., European Journal of Clinical Chemistry and Clinical Biochemistry: Journal of the Forum of European Clinical Chemistry Societies 1993, 31:295-302). One of the problems of using ultra-centrifugation, which separates analytes such as lipoproteins based on density, is that the cut-off between fractions cannot be objectively defined and the method is time-consuming. Chromatographic separation of analytes such as lipoproteins is possible based on size-exclusion chromatography (SEC), also known as gel filtration chromatography or gel permeation chromatography using, as column packing material, TSK G5000 (Hara I. et al. Journal of Biochemistry 1980, 87:1863-1865) or Superose 6 (Kieft K. A. et al., Journal of Lipid Research 1991, 32:859-66). The smaller particles or molecules are retained by the chromatography column because they can diffuse into the pores of the column material. This causes their retention, while larger particles or molecules that are too big to diffuse into the pores will be retained to a lesser extent.

There have been developments of the detection methods of the cholesterol and other lipids in the eluents. It is possible to detect cholesterol, cholesterol esters, triglycerides or other lipid classes (Hara I. et al. Journal of Biochemistry 1980, 87:1863-1865; Kieft K. A. et al., Journal of Lipid Research 1991, 32:859-66; Usui S. et al., Journal of Lipid Research 2002, 43:805-14; Okazaki M. et al., Journal of Chromatography B, Biomedical Sciences and Applications 1998, 709:179-87; März W. et al., Clinical chemistry 1993, 39:2276-81; Okazaki M. et al., Clinical Chemistry 1997, 43:1885-90; Garber D. W. et al., Journal of Lipid Research 2000, 41:1020-6) in post column reaction with enzymes or reagents.

### SUMMARY OF THE INVENTION

The present inventors have realised that it is possible to provide a system and method for separating and analysing an analyte from a mixture of components including an analyte on a substantially continuous basis. Where there is provided a flow of a liquid carrying a mixture of components including an analyte in which, for example, the nature or concentration of the analyte varies over time, it is of interest to be able to analyse the analyte and said variation. However, as explained above, there are various circumstances in which the preferred analytical technique is not compatible with some of the components in the liquid, or indeed with the liquid itself. The present inventors have realised that collection of the liquid into discrete but homogenous samples allows treatment of the liquid to separate the analyte for analysis, but this in turn significantly reduces the time-based resolution of the analysis, unless a very large number of samples is taken, in which case the process is impractically laborious and inefficient.

The present invention has been devised in order to address at least one of the above problems. Preferably, the present invention reduces, ameliorates, avoids or overcomes at least one of the above problems.

In one general aspect, the present invention provides substantially continuous liquid-liquid partition and separation in order to treat a substantially continuous inlet flow prior to analysis, where the inlet flow would otherwise be incompatible with a selected analytical technique.

In a first preferred aspect, the invention provides an extraction and analysis system comprising a liquid-liquid extraction apparatus and an analysis apparatus, wherein the liquid-liquid extraction apparatus is configured to receive a substantially continuous inlet flow of a first liquid, the first liquid carrying a mixture of components including an analyte, the liquid-liquid extraction apparatus being operable to receive a second liquid for contact with the first liquid, the second liquid being substantially immiscible with the first liquid, in order to partition the analyte and/or another component carried by the first liquid preferentially into the second liquid substantially continuously and to subsequently separate the first and second liquids substantially continuously, the system further comprising an outlet flow conduit operable substantially continuously to conduct the analyte, in a corresponding flow of said first or second liquid, to the analysis apparatus for substantially continuous analysis.

In a second preferred aspect, the invention provides a use of the system of the first aspect, to separate and analyse an analyte from a mixture of components including the analyte.

In a third preferred aspect, the invention provides a method of extracting and analysing an analyte substantially continuously from a mixture of components including the analyte, the method comprising the steps:

providing a substantially continuous inlet flow of a first liquid, the first liquid carrying a mixture of components including an analyte, to a liquid-liquid extraction apparatus;

providing the liquid-liquid extraction apparatus with a second liquid which is substantially immiscible with the first liquid, contacting the first and second liquids, allowing the analyte and/or other component carried by the first liquid to preferentially partition into the second liquid substantially continuously; and, subsequently,

separating the first and second liquids substantially continuously;

substantially continuously conducting the analyte, in a corresponding outlet flow of said first or second liquid, to an analysis apparatus; and

substantially continuously analysing a property of the analyte in the flow over time.

The system and method of the first, second and third aspects of the invention can provide improved analytical resolution compared to conventional approaches. In addition, they are more time-effective and consequently more cost-effective.

In another general aspect, the invention provides substantially continuous liquid-liquid extraction in order to treat an outlet flow from a separation apparatus.

In a fourth preferred aspect, the invention provides a separation and extraction system comprising a separation apparatus and a liquid-liquid extraction apparatus, wherein the separation apparatus is configured to receive an input mixture including an analyte, the separation apparatus being capable of substantially separating the analyte in the input mixture, the separation apparatus being configured to provide a substantially continuous outlet flow of first liquid, the first liquid carrying a mixture of components including the analyte, the system further comprising a flow conduit operable substantially continuously to conduct the first liquid carrying the analyte to the liquid-liquid extraction apparatus, wherein the liquid-liquid extraction apparatus is configured to receive the substantially continuous outlet flow of first liquid from the separation apparatus, the liquid-liquid extraction apparatus being operable to receive a second liquid for contact with the first liquid, the second liquid being substantially immiscible with the first liquid, in order to partition the analyte and/or another component carried by the first liquid preferentially into the second liquid substantially continuously and to subsequently separate the first and second liquids substantially continuously.

In a fifth preferred aspect, the invention provides a use of the system of the fourth aspect, to separate an analyte from a mixture of components including the analyte.

In a sixth preferred aspect, the invention provides a method of separating and extracting an analyte from a mixture including the analyte, the method comprising the steps:

inputting an input mixture including an analyte into a separation apparatus, substantially separating the analyte in the input mixture to provide a substantially continuous flow of first liquid from the separation apparatus, the first liquid carrying a mixture of components including the analyte;

substantially continuously conducting the flow of first liquid to a liquid-liquid extraction apparatus;

providing the liquid-liquid extraction apparatus with a second liquid which is substantially immiscible with the first liquid, contacting the first and second liquids, allowing the analyte and/or other component carried by the first liquid to preferentially partition into the second liquid substantially continuously; and, subsequently,

separating the first liquid and second liquid substantially continuously, to provide the analyte in a corresponding substantially continuous outlet flow of said first or second liquid.

The system and method of the fourth, fifth and sixth aspects of the invention can provide improved separation of mixtures, for example, in preparation for analysis compared to conventional approaches. In addition, they are more time-effective and consequently more cost-effective.

The first, second, third, fourth, fifth and/or sixth aspect of the invention may have any one or, to the extent that they are compatible, any combination of the following optional features.

The first and second liquids are, by their nature, substantially immiscible. The immiscibility may result from the liquids being respectively polar and non-polar, organic and aqueous, or hydrophobic and hydrophilic. In preferred embodiments, the first liquid is substantially hydrophilic and the second liquid is substantially hydrophobic. A preferred hydrophilic liquid includes, for example, an aqueous solution. The hydrophilic liquid may contain other components such as dissolved salts, for example from non-volatile buffers such as PBS buffer, that are used during of a separation method such as chromatography. The skilled person will be aware that other suitable liquids and buffers can be used for different separation methods. Examples of alternative buffers include sodium chloride, phosphate buffer, Tris base, urea, guanidine, azide, sodium dodecyl sulphate, n-octyl-β-glucopyranoside, and lauryldimethylamine oxide.

A preferred hydrophobic liquid includes an organic liquid. The organic liquid may be any of a number of suitable liquids known to the skilled person such as chloroform, ethyl acetate, dichloromethane, diethyl ether, tetrahydrofuran, methyl tert-butyl ether, petroleum ether, aromatic and non-aromatic hydrocarbons including toluene, hexane, octane, and the like.

The liquid-liquid extraction apparatus provides partitioning and separation of analyte. That is, extraction is used herein to refer to partitioning and separation as discussed below. The liquid-liquid extraction apparatus may alternatively be called a liquid-liquid partition and separation apparatus. The liquid-liquid extraction apparatus may comprise a single module, so that extraction occurs in the same unit, or may be a plurality of modules or units. The liquid-liquid extraction apparatus may be a single module. This is not only space efficient, but resolution may be improved by reducing the volume of components. Since volume is related to the distance between a plurality of modules, resolution may be improved by using a single module. Therefore, the use of a single module will decrease the chance of peak broadening. The liquid-liquid extraction apparatus may comprise a contact region configured and dimensioned to allow the first and second liquids to contact each other in a slug flow regime. This arrangement allows optimal partitioning of analyte in the slug flow regime. The slug flow regime occurs when the immiscible first and second liquids are in contact with one another and flow together along e.g. a conduit (see FIG. 1 and the discussion below). The phases form alternate liquid droplets, also called slugs, in the conduit, that span a lateral dimension of the conduit. Components in the first liquid are advantageously able to diffuse into the second liquid when the component's hydrophilicity more closely matches that of the second liquid than that of the first liquid. Conversely, those components whose hydrophilicity is better matched to the first liquid will not diffuse out of the first liquid. Accordingly, the components of the mixture are partitioned.

The contact region may be of any suitable dimensions to provide partitioning of the components of the mixture over a suitable time scale and flow rate. It may comprise a conduit along which the first and second liquids flow in the slug flow regime. The conduit may be of any suitable internal cross-sectional shape, for example circular, oval, rectangular, square etc. The conduit may be of any suitable internal dimension to induce slug flow. For example, the conduit may have an internal diameter in the range 0.01 mm to 20 mm, for example about 0.25 mm, which in some embodiments allows rapid partitioning of analyte into the preferred solvent phase (first or second liquid).

The liquid-liquid extraction apparatus may advantageously carry out separation of the first and second liquids using a membrane, capable of allowing the passage of one of the liquids but not another. In some embodiments, the membrane is hydrophobic, allowing the passage of for example organic liquids but not aqueous liquids. In some embodiments, the membrane has pore sizes of between about 0.2 and 10 μm, for example between about 0.2 and 5 μm, for example between about 0.2 and 1 μm. In some embodiments, the pore sizes may be about 0.22 μm, 1 μm, 5 μm, or 10 μm.

The liquid-liquid extraction apparatus may be operated at a pressure above ambient pressure. This encourages timely separation of the first and second liquids. Suitable pressurisation may be conveniently provided using, for example, a source of compressed gas.

Using the analysis apparatus, it is possible to analyse time-dependent variations in, for example, nature or concentration of analyte in a flow of liquid. The analysis may include analysing whether an analyte is present or absent. The analysis may include analysing a property of an analyte (when it is present). The analyte apparatus may be capable of analysing a number of different analytes in a mixture.

The analysis apparatus may comprise a sample preparation portion and a sample analysis portion. The presence of the sample preparation portion means that the liquid carrying the analyte can be advantageously altered to a form suitable for analysis. For example, the analyte may be ionised and/or the flow of the liquid carrying the analyte can be broken up into droplets. The sample preparation portion may include an ionisation source, such as an electrospray ionisation (ESI) unit. Advantageously, the invention provides partitioning and separation of salts (which may be present in the inlet flow to the liquid-liquid extraction apparatus) from the analyte using the liquid-liquid extraction apparatus, prior to the arrival of the analyte at the analysis apparatus. Liquids with high salt concentrations, such as those with a salt concentration of 100 μM or higher, tend to lead to corona discharge in an ESI source if fed directly to an ESI source. Thus, it is possible to overcome a difficulty with corona discharge and/or salt deposit build-up at the sample preparation portion without needing to use alternative and potentially less effective buffers. The preferred embodiments of the invention therefore allow the use of effective buffers in a separation stage before the liquid-liquid extraction apparatus and yet remove the potentially problematic salts before analysis of the analyte. This is done without having to collect fractions and separate the salts out off-line.

The sample analysis portion may comprise a mass spectrometer. The sample analysis portion may comprise a single quadrupole mass spectrometer. The sample analysis portion may comprise a high resolution tandem mass spectrometer. As discussed above, the first liquid may contain salts and, in the absence of the partitioning and separation, the sample introduction orifice of a mass spectrometer may become occluded through the build-up of the salts. The system of the invention may advantageously overcome this difficulty by partitioning and separating the analyte and salts.

The substantially continuous flow of the first liquid may be provided by a separation apparatus. The separation apparatus may include a chromatography column, so that the substantially continuous flow of the first liquid is provided by the eluent of the chromatography column. Advantageously, suitable chromatographic techniques substantially separate an analyte from other components in a mixture. A number of different types of chromatography column may be suitable for use in the system of the invention, either alone or in combination. Examples of chromatography columns include affinity based chromatography (affinity chromatography), which involves separating distinct components of mixtures (especially biochemical mixtures) based on interactions such as those between antigen and antibody, enzyme and substrate or receptor and ligand, and size-exclusion chromatography (gel permeation chromatography or gel filtration chromatography), which involves separating distinct components of mixtures based on the size of the components. The separation apparatus may include at least one of a size-exclusion chromatography column and an ion exchange chromatography column. An ion exchange chromatography column may be an anion exchange chromatography column.

Suitable flow rates for use with the chromatography column will be known to the skilled person. Typical flow rates may range from, for example, 10 μL/min to 1 mL/min, for example around 50 μL/min, for example around 500 μL/min, for example 750 μL/min. The skilled person will also understand how to adjust a flow rate for optimal separation using known methods.

The system of the invention may further comprises a detector arranged within the system upstream of the liquid-liquid extraction apparatus. The detector may be arranged between a separation apparatus and the liquid-liquid extraction apparatus.

Advantageously, this can allow the detection of an analyte in the continuous flow of first liquid. A suitable detector includes for example a photodiode array detector. In other examples, the photodiode array may be absent, or may be replaced by some other suitable analysis equipment such as for example UV detectors (single or multiple wavelength) or fluorescence detectors.

The analyte may include a biomolecular component, for example lipoproteins. The analyte may include one or more of a lipid, protein, antibody and peptide. The system of the invention is considered to be particularly advantageous for the analysis of lipids associated with lipoproteins, for example, because the liquid-liquid extraction apparatus helps to disrupt the associations between the hydrophobic and hydrophilic components, and the lipid portion is partitioned in one liquid while leaving salt and hydrophilic components in the other liquid.

In other examples, the analyte may include a polymer. The polymer may be a biopolymer. The polymer may be a naturally-occurring polymer or the polymer may be a man-made or synthetic polymer (Zhu & Marchant. Expert Review of Medical Devices, 2011 8: 607-626). In one example, the polymer is a polyethylene glycol (PEG) polymer. The polymer analyte may be present in a mixture of polymers, which mixture may include a mixture of biopolymers, a mixture of naturally-occurring polymers, and/or a mixture of man-made or synthetic polymers, and may include two or more of a biopolymer, a naturally-occurring polymer and a man-made or synthetic polymer.

### BRIEF DESCRIPTION OF THE DRAWINGS

Embodiments of the invention will now be described by way of example with reference to the accompanying drawings in which:

FIG. 1 shows a schematic view of two immiscible liquids flowing along a conduit in a slug flow regime in a liquid-liquid extraction apparatus for use in an embodiment of the invention.

FIG. 2 shows a schematic layout of a system of an embodiment of the invention.

FIG. 3 shows chromatograms of five lipid classes obtained using an embodiment of the invention.

FIG. 4 shows average mass spectra of an unseparated plasma sample and the subsequently separated lipoprotein fractions obtained using an embodiment of the invention.

FIG. 5 is a bar graph showing the relative amount of triglycerides (TAGs) and cholesterols in VLDL particles in samples taken from fasting and non-fasting patients obtained using an embodiment of the invention.

FIG. 6 shows a chromatogram (a) and mass spectra (b) of VLDL lipoproteins in fasting and non-fasting state obtained using an embodiment of the invention.

FIG. 7 shows a schematic view of a back-pressure regulator for a liquid-liquid extraction apparatus for use in an embodiment of the invention.

FIG. 8 shows a UV chromatogram (230 nm) with peak positions showing HDL and LDL (a) and MS chromatograms showing (i) sodiated ions of linoleate cholesterol ester (CE(18:2)) and (ii) a triglyceride (TAG(52:2)) (b) obtained in an embodiment of the invention.

FIG. 9 shows a UV trace (190 nm) (a); TIC (total ion current) of the CMS (b) and MS spectra (c) at (i) 3 min (ii) 4.4 min and (iii) 5.75 min of PEG standards separated using a Phenomenex Yarra 400 column in an embodiment of the invention.

FIG. 10 shows UV trace (190 nm) (a); TIC (total ion current) of the CMS (b) and MS spectra (c) at (i) 14 min (ii) 16 min and (iii) 18 min of PEG standards separated using Agilent aquagel-OH column in an embodiment of the invention.

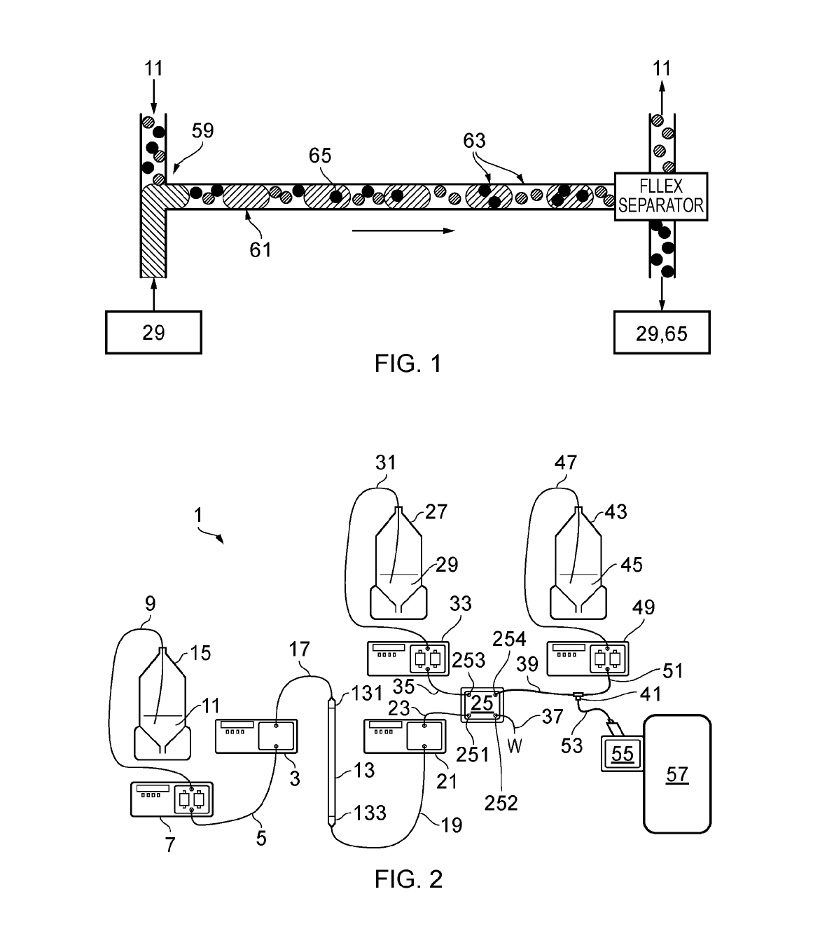

### DETAILED DESCRIPTION OF THE PREFERRED EMBODIMENTS AND FURTHER OPTIONAL FEATURES OF THE INVENTION

Lipoprotein concentration is a commonly measured biochemical parameter. Lipoproteins are complexes of lipids with proteins. Most lipids are poorly soluble in water, and so are transported through the circulation as lipoproteins. Lipoprotein particles are diverse in size and composition, and are commonly divided based on the hydrated density into the high density lipoprotein (HDL), low density lipoprotein (LDL) and very low density lipoprotein (VLDL) or triglyceride (TAG) fraction (Havel R. J. et al., The Journal of Clinical Investigation 1955, 34:1345-53). This separation into three classes has been shown to be limited, and that there are more intermediate classes of lipoproteins. Different densities and sizes are obtained by the combination of different proteins that maintain the organisation of lipoprotein particles. The actual lipid composition is becoming more relevant now that lipidomic techniques are able to give a detailed profile of the lipids in a plasma sample, which in turn gives rise to questions about the organisation of the lipids and whether or not the lipids are specific for particular lipoprotein particles.

Lipoprotein particles could, in principle, ionise in electrospray, although their size is at the upper limit of what has been achieved in the gas phase (Sharon M., Robinson C., Annual Review of Biochemistry 2007, 76:167-193). The breakup of these particles in the gas phase would also be theoretically possible but the trapping of the individual lipid ions is considered to be extremely challenging.

The inventors made several attempts to use post column dissociation of the lipoprotein after SEC through the addition of organic solvents (for example CHCl₃, CHCl₃/MeOH, MeOH/IPA etc.) at flow rates of 200 to 500 μL/min, to dissociate the lipoprotein particles. In classic lipid analysis through, for instance, the Folch extraction (Folch J. et al., The Journal of Biological Chemistry 1957, 226:497-509), lipids are extracted through liquid-liquid partitioning, where chloroform and methanol dissociate the lipoprotein particles and the lipids are taken up by the organic phase. The aim of the post column addition of these organic solvents was to achieve a similar dissociation. Adjustable flow splitters were used, with the aim of having the eluent with a highly reduced salt concentration arriving at the ESI probe. However, it was found that the levels of salt were still too high to produce a sustainable spray. Further dilution through higher flow rates of the post column addition were not practical and compromised the sensitivity.

### EXAMPLE 1

Separation and analysis of lipids from lipoproteins was carried out using an embodiment of the system and method of the invention, which were found to overcome the above difficulties. They also allowed detection and analysis of the lipids without needing to use a separate post column reaction.

### Materials and Methods

### Reagents

Methanol, n-isopropanol chloroform (all HPLC grade), and ammonium acetate were purchased from Sigma (Darmstadt, Germany).

### Characteristics of Blood Donors

Plasma was obtained from 5 healthy blood donors and samples were collected at 3 different time points. Donors did not take any medication within 2 weeks before blood figure. Informed consent of all donors in written form was obtained. Blood samples were taken by venipuncture.

### Equipment

FPLC: A Shimadzu Prominence UFLC system with three LC-20AD pumps and SPD-M20A photodiode array detector was used.

The LTQ Orbitrap Velos was set up for data dependent fragmentations. Every cycle consisted out of a full scan, with mass range: 200-1500 m/z; resolution 100,000).

### Lipoprotein Separation by FPLC

Freshly thawed plasma samples were diluted 1:5 with PBS before separation. Lipoproteins particles were substantially separated using a previously described method (Wiesner P, et al., Journal of Lipid Research 2009, 50:574-85) with a Superose 6 PC 3.2/30 column (GE Healthcare Europe GmbH, Munich, Germany) and PBS as a mobile phase (at 50 μL/min).

### Liquid-Liquid Partitioning and Separation

A schematic overview of an instrumental set-up is shown in FIG. 2. The system 1 shows that an autosampler 3 was connected by a conduit 5 to a column pump 7, which was in turn connected by a conduit 9 to a separation buffer 11 of phosphate buffered saline (PBS). PBS buffer 11 was used for separation on the column 13. The PBS 11 was contained in a container 15, and the conduit 9 was inserted into the buffer 11 at one end.

The autosampler 3 was connected via conduit 17 to the column 13 at the column input end 131. Column 13 was a size exclusion chromatography column. A flow rate of 50 μl min⁻¹ of PBS 11 was used to achieve the separation of the lipoproteins. At the other end of the column 133, a conduit 19 was extended to a photodiode array (PDA) 21.

PDA 21 was in turn connected via conduit 23 to a liquid-liquid partitioning and separation apparatus 25. The apparatus 25 was a FLLEX module (version 1.0, Syrris, as described in Syrris Ltd: Asia FLLEX Manual dated 22 Sep. 2012,) capable of performing both partitioning and separation using a microfluidic setup.

The field of flow chemistry (Varas A, et al., ChemSusChem 2012, 5:1703-1707), uses a continuous flow in which chemical synthesis is performed, for instance the mixing of a flow of reagents with a flow of a catalyst through a coil at a specific temperature to initiate a reaction. The product of the reaction commonly needs purification, and liquid-liquid partitioning may be suitable. The FLLEX module provides this type of set-up.

Container 27 contained an organic solvent 29, which was a mixture of CHCl₃/MeOH 2:1. A conduit 31 was open at one end in the solvent 29 and at the other end was connected to an organic phase pump 33. The organic phase pump 33 pumped solvent 29 from the container 27 through the conduit 31 to the FLLEX module 25 via conduit 35. A flow rate of 50 μL/min was used.

Partitioning of the lipid occurred in the FLLEX module 25. The aqueous phase including PBS buffer 11 and the organic solvent 29 were brought into contact at junction 59 and the combined liquids were flowed along a conduit 61 with circular cross-section and internal diameter of 0.25 mm. This induced a slug flow regime 63 as described above. The contact of the organic solvent 29 induced dissociation of the lipid from the protein and the lipid 65 diffused into the organic solvent 29 thereby causing preferential partitioning into the organic solvent 29. The organic solvent 29 containing the lipid 65 for analysis was then separated from the aqueous phase containing PBS buffer 11 as described below.

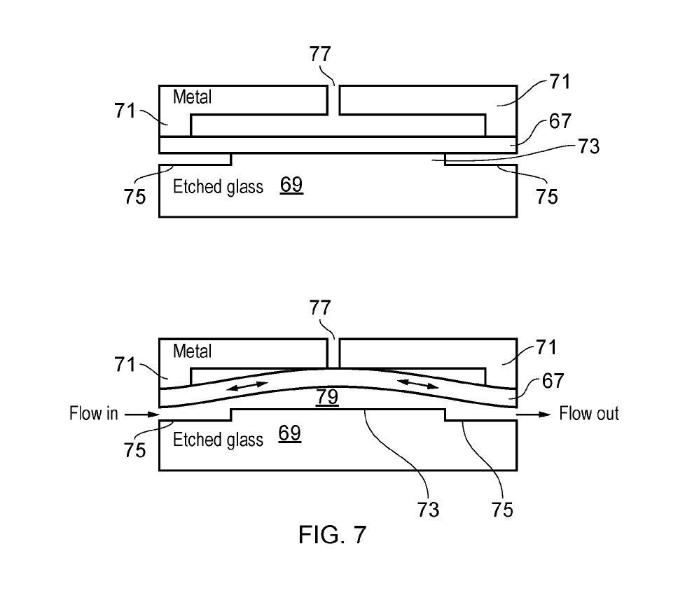

The FLLEX module 25 has two opposed slides that combine form a microfluidic channel through which solvents can flow. The slides may both be glass; alternatively, the slide through which the organic phase passes may be made of polyether ether ketone (PEEK) or some other suitable material as understood by the skilled person. Between the slides was a Teflon® membrane with pores of 0.22 μm diameter. The hydrophobic nature of the Teflon® repelled the water phase, but the organic phase 29 could pass through the pores. The mixed phases 11, 29 flowed through the microfluidic channel and at the end are outlets in both slides. To stabilise the partitioning the flow was held at a constant back pressure (see FIG. 7), using nitrogen, with a small off-set that could be adjusted to obtain perfect separation of the two liquids.

Separation performance was controlled using two back pressure regulators, as shown in FIG. 7. The back pressure regulator has a polymer diaphragm 67 held between etched glass 69 on one side and metal 71 on the other side. The etched glass 69 has an upper face with a raised portion 73 on which the polymer diaphragm 67 can rest, and lower portions 75, 75 either side of the raised portion 73. When the polymer diaphragm 67 is in a flat configuration, there is contact with the raised portion 73. The metal 71 has a “U” shape with a gap 77 relevant to the gas pressure. When a gas pressure is supplied to the back pressure regulator diaphragm, the upstream fluid flow must equal or exceed the gas pressure in order to flow. So, when the liquids are being pumped, the liquid pressure upstream of the back pressure regulator rises to match the gas pressure applied to the other side of the diaphragm 67. The shape of the etched glass 69 and metal 71 either side of the polymer diaphragm 67 allows the diaphragm 67 to bend so that it does not contact the raised portion 73 to produce a gap 79, and thereby allow flow through the gap 79. The control of the off-set is important for successful separation of different pairs of solvents, since different solvent pairs require different cross-membrane pressures. The skilled person will understand how to determine the off-set for optimal separation.

In the FLLEX module 25, the mixture of the two solvent phases 11 and 29 was passed through a 250 μl loop before entering the microfluidic channel. The back pressure was set 4 bars with a differential pressure of 0.23 bars, which yielded a stable separation between the two phases. The skilled person will understand how to adjust the pressure to determine optimum conditions.

As well as having two inputs 251 and 253, the FLLEX module has two outputs 252 and 254. Output 252 was connected to waste W via conduit 37. Conduit 37 removed the unwanted aqueous component from the FLLEX module 25. Output 254 was connected via conduit 39 to a T junction 41.

Container 43 contained an ionisation modifier 45. The ionisation modifier 45 was a mixture of isopropanol/MeOH containing 7.5 mm CH₃CO₂NH₄. The modifier 45 was provided at a flow rate of 150 μL/min. The ionisation modifier 45 is for facilitating a stable spray in the ESI source 55, and to provide ions for the ionisation of neutral lipids. Suitable ionisation modifiers will be apparent to the skilled person and may include for example formic acid, ammonium formate or ammonium acetate. Ionisation modifier 45 was conducted through conduit 47 from container 43 through pump 49 and conduit 51 to T junction 41.

The ionisation modifier 45 and analyte to be measured from the FLLEX system 25 were mixed at T junction 41 (also known as a flow splitter), and the sample was sent via conduit 53 to the ESI source 55, and analysed by MS unit 57. Spectra were obtained using a LTQ Orbitrap Velos.

### Analysis

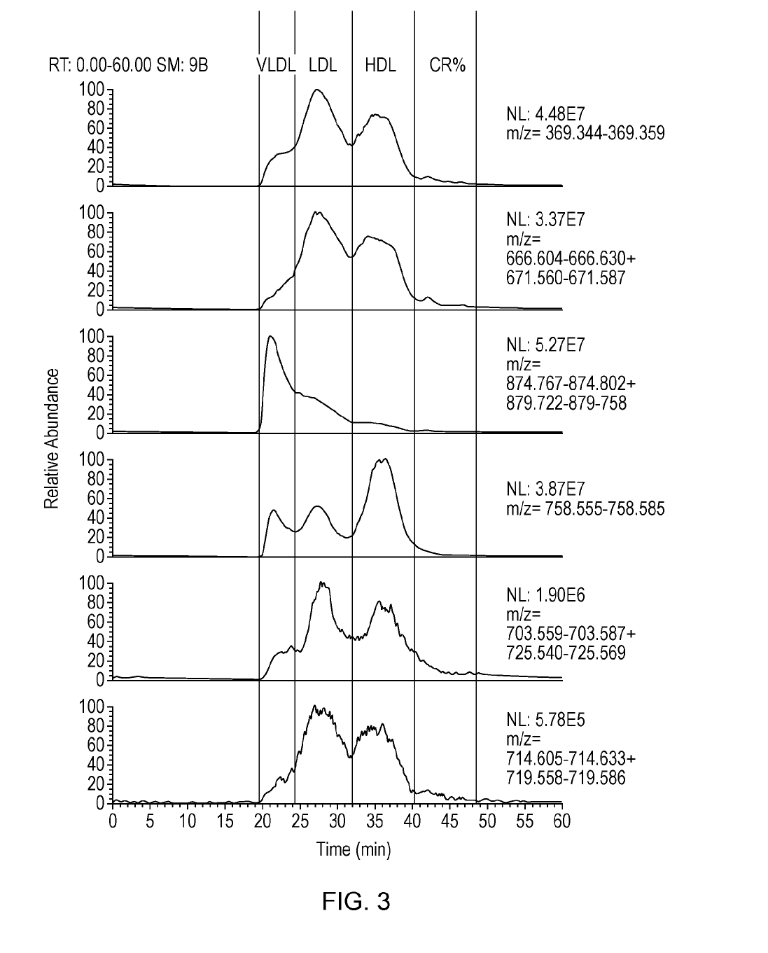

The separation of lipoproteins has been described previously (Wiesner P. et al., Journal of Lipid Research 2009, 50:574-85; Scherer M, et al., Biochimica et Biophysica Acta 2011, 1811:68-75). No difficulties were encountered in reproducing this work in relation to the separation of the lipoproteins in our samples (see FIG. 3). FIG. 3 shows extracted ion chromatograms of four lipid classes obtained during preparation of the lipids using a system and method according to an embodiment of the invention. In each case, VLDL eluted before LDL, which eluted before HDL, which eluted before CR (chylomicron remanant). Top line: free cholesterol (relative abundance LDL>HDL>VLDL>CR); second line: linoleate cholesteryl ester (666.616+671.574: CE(18:2)⁺NH₄⁺ and CE(18:2)⁺Na⁺) (relative abundance LDL>HDL>VLDL>CR); third line: triglycerides (874.775, 879.735: TAG(52:2)⁺NH₄⁺ and TAG(52:2)Na⁺)) (relative abundance VLDL>LDL>HDL>CR); fourth line: phosphocholine (748.578 PC(34:2)) (relative abundance HDL>LDL˜VLDL>CR); fifth line: sphingolipids (703.574: SM(34:1)) (relative abundance LDL>HDL>VLDL>CR); sixth line: Docosahexaenoate cholesteryl ester (714.616+719.574: CE(22:6)⁺NH₄⁺ and CE(22:6)⁺Na⁺) (relative abundance LDL>HDL>VLDL>CR).

The resolution of this separation is limited and there is a considerable overlap between the different lipoprotein particles, which has also been reported by others (Wiesner P. et al., Journal of Lipid Research 2009, 50:574-85; Scherer M, et al., Biochimica et Biophysica Acta 2011, 1811:68-75).

The on-line liquid-liquid extraction apparatus introduced a peak broadening of about 10 to 20%, but this could be limited by using a small (250 μL) volume for the mixing loop in the FLLEX system 25 and small diameter tubing. The delay of the peaks was around 4 to 5 minutes between the PDA detector 21 and the mass analyser 57.

The system was stable and gave reproducible results. Protein denaturation could cause the membrane to block resulting in impaired separation of the two phases 11, 29 and a loss of signal. Replacement of the membrane solved this difficulty without any further problems and did not demand any changes or alteration of the setting of the system.

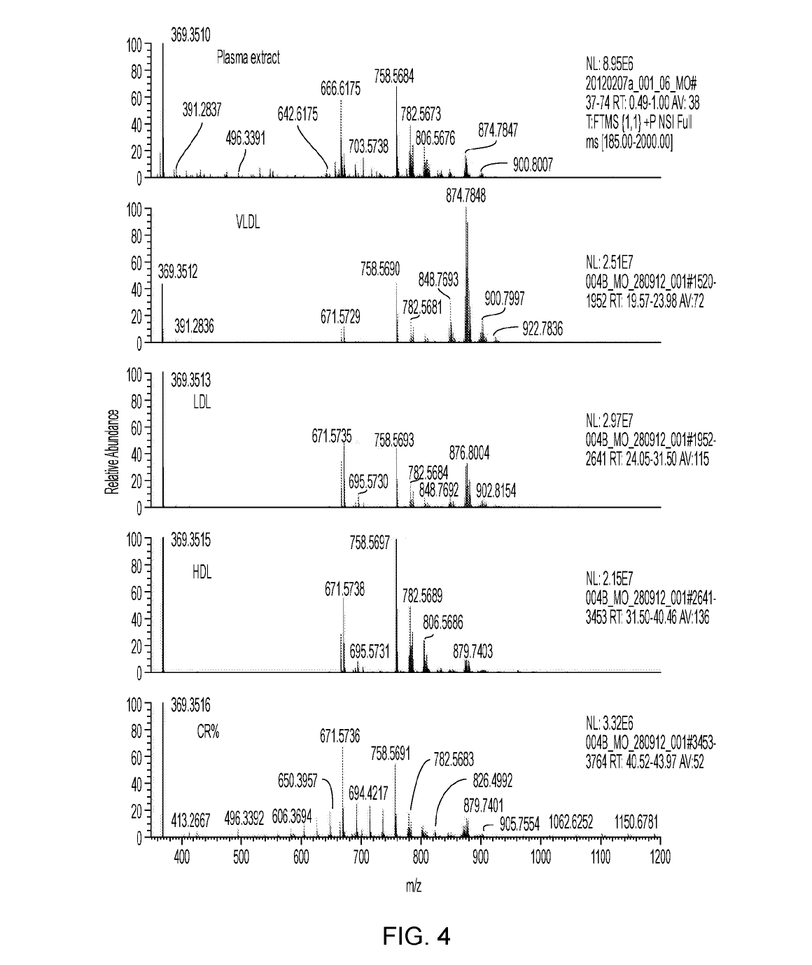

The three main classes showed clear differences in their lipid composition (see FIG. 4). FIG. 4 shows average mass spectrum (350-1200 m/z) of the different lipoprotein fractions VLDL, LDL, HDL and CR, in comparison to a lipid extract of the same plasma sample before separation of the lipoproteins using a system according to FIG. 2. Plasma was obtained from a healthy human after 12 hours of fasting. Although most lipids from the total lipid extract can be found in one or more of the lipoprotein fractions, there is also a number of lipids for which the levels are much lower in any of the lipoprotein fractions than in the complete extract, showing that not all lipids are circulating as part of lipoprotein particles. The VLDL fraction mainly contained triglycerides and cholesterol/cholesterol and eluted between 19 and 24 minutes. The LDL fraction contained mainly cholesterol (esterified and free) eluted between 24 and 32 minutes. The HDL fraction had a relatively large amount of phospholipids and eluted between 31 and 41 minutes. The fourth fraction, which eluted between 40 and 49 minutes, is the chylomicron remnant (CR).

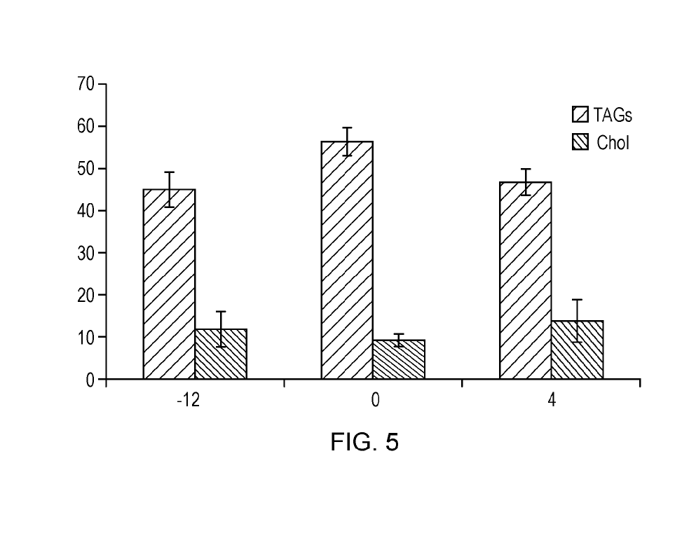

Fasting and non-fasting plasma samples of healthy humans were used to determine the effect of fasting on the lipoprotein composition and to determine the inter-individual differences. The results showed that the VLDL fraction was increased in the fasting blood samples. The embodied method of the invention did not require the pooling of the samples and therefore allowed comparison of the composition and size of the lipoprotein particles. This confirmed earlier observations (Björkegren, J., et al., Journal of Lipid Research, 1998, 39:1412-20) that the total amount of circulating triglycerides increased due to fasting (see FIG. 5).

FIG. 5 shows the relative amount of each of the lipid classes (TAGs and cholesterols) in the VLDL particles in fasting (0) and non-fasting (−12 and +4 hours) samples. Error bars are shown in the figure. The amount of TAGs was greatest in fasting than in non-fasting samples, while the amount of cholesterols was lower in fasting than in non-fasting samples. In each case, the amount of TAGs was greater than the amount of cholesterols.

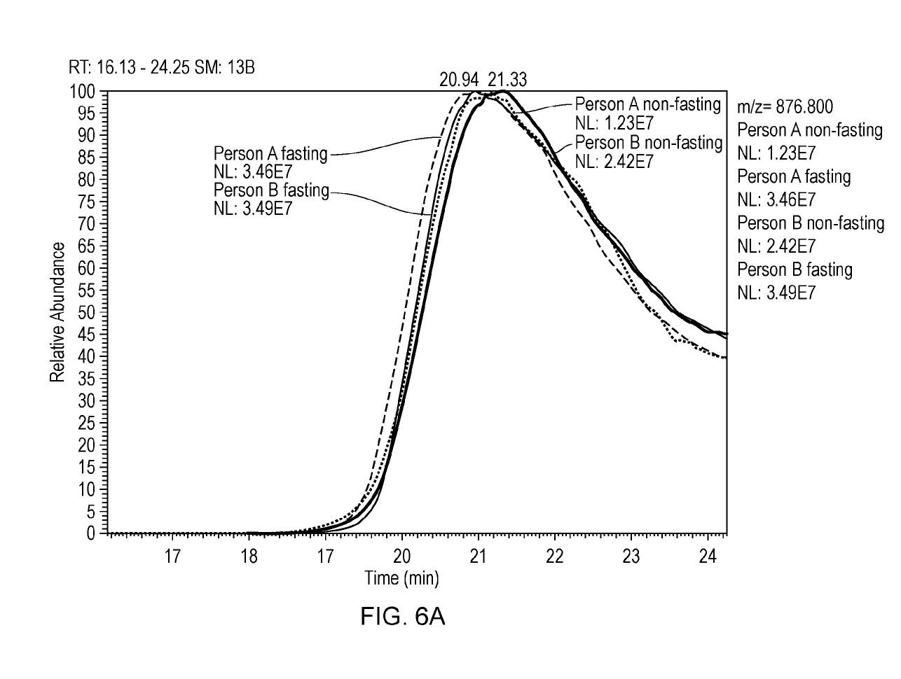

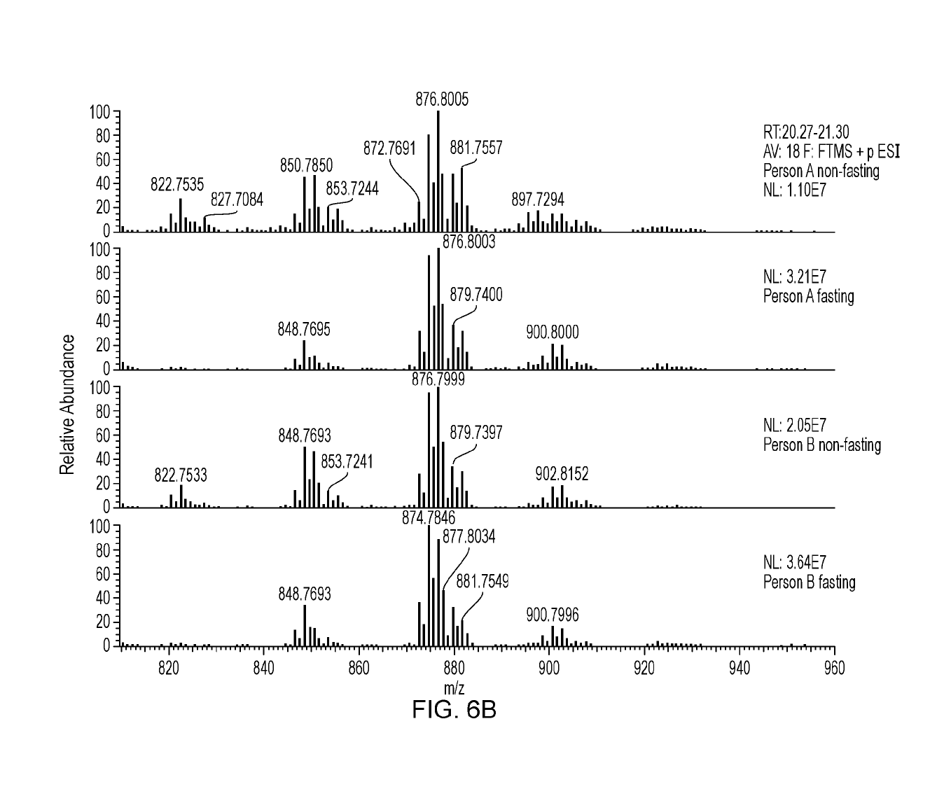

FIG. 6 shows the difference in the VLDL lipoproteins in size and composition in fasting and non-fasting state. Fasting leads to an increase of the VLDL particle size (lower retention time) and to a decrease of triglycerides with shorter more saturated fatty acids.

The size of the VLDL particles increased as shown in FIG. 6. This observation is based on the intensity of the ion 786.800 m/z (TAG(52:2)) which reached a maximum earlier in fasting samples compared to non-fasting samples from the same person. As the size-exclusion chromatography retains smaller particles better than larger particles it was theorized that fasting led to VLDL size increase. In addition it was possible to compare the triglyceride composition which showed that the fasting VLDL contained relatively longer chain unsaturated fatty acids. This was most notable for the ions from TAG(48:1) which were clearly present in the VLDL particles of non-fasting volunteers, while in fasting samples the level was much lower. The increase in desaturation can be seen in the ratio between ions 900.800 m/z and 902.815 m/z (TAG(54:4) and TAG(54:3)). In the fasting samples the 900.800 m/z was more abundant than the 902.815 m/z and in the non-fasting samples it was the other way around.

Lipidomics is an orthogonal approach to standard biochemical measurement of lipoprotein classes which profiles fatty acids or intact lipid molecules. This usually starts with the extraction of the lipid molecule from the plasma or serum into an organic solvent which leads to dissociation of the lipoproteins (Folch J., et al., 1957 The Journal of Biological Chemistry, 1957, 226:497-509) (see top line FIG. 4 which shows a mass spectrum of a plasma extract). Thus far it has not been possible to combine the two approaches in one analytical system. The system and method of the invention combines flow chemistry, analytical chemistry and biochemical analysis, and can give information about both the lipoprotein fractions and their detailed lipid composition using one analysis, yielding an unprecedented insight into the composition of lipoproteins based on their size.

The embodiment of the invention described herein has at least two major advantages over what has been published in the field of lipoprotein analysis based on size exclusion. It is faster and more convenient than any other approach that relies on mass spectrometry. Previous work required fraction collection and used off-line sample work up to determine the lipid composition of these fractions.

A second advantage is that through the combination with high resolution mass spectrometry it is possible to determine contribution of specific lipids to the different lipoprotein fractions. High resolution mass spectrometry allows the extraction of ions with very small mass windows which means that only signals from ions with that particular molecular formula contribute to the signal (Koulman A. et al., Rapid Communications in Mass Spectrometry, 2009, 23:1411-8). With careful analysis of the retention time it may be possible to determine if specific lipids are dependent of the size or determining the size of lipoproteins.

The ability to determine in detail the lipid composition of the lipoprotein separated by size using the present embodiment of the invention has revealed some novel information. For most lipoprotein particles, the ratio between free cholesterol and cholesteryl esters (measured as the ions of cholesteryl linoleate) is the same, while for the large VLDL particles the ratio is different, with an increased amount of free cholesterol (see FIG. 4). The largest VLDL particles contain relatively more free cholesterol.

Another observation is that in all of the lipoprotein particles the esterified cholesteryl was present as linoleate cholesteryl (CE(18:2)). In most samples it was between 85% and 90% of all cholesteryl esters was CE(18:2). The levels of palmitate cholesteryl (CE(16:0)), oleate cholesteryl (CE(18:1)) and arichidonate cholesteryl (CE(20:4)) were much lower than in lipid extracts from plasma. This suggests that these cholesteryl esters are not only part of the lipoproteins, but are trafficked differently in blood.

In the embodiment described above, the chromatography column was not suitable for retention of CR and therefore this fraction was not well captured. The system of the invention can accommodate a range of columns (Okazaki M., et al., Journal of Chromatography B, 1998, 709:179-187) or a combination of columns. CR is separable if an alternative column material is used or if columns are used in sequence. For example, Okazaki M., et al. (Journal of Chromatography B, 1998, 709:179-187) and Nakano T., et al. (Clinica Chimica Acta 2008, 390:38-43) used two columns to increase the resolution of the system. A combination of two columns each with a different column material could be used to separate both larger and smaller components, for example where the first column retains smaller particles such as HDL and CR while the second column retains the larger particles, and will therefore separate the intact chylomicrons, VLDL and LDL.

In the following examples, the inventors were able to apply the systems and methods of the invention to different separation apparatuses, different flow rates, different analytes to be separated, and different analysis apparatuses.

### EXAMPLE 2

### Lipoprotein Separation by Ion Exchange Chromatography

In this example, a TSK-GEL DEAE-NPR column (4.6 mm ID×35 mm, 2.5 μm) was used with a gradient of 50 mM Tris-HCl+1 mM ethylenediamine tetraacetic acid disodium salt, dihydrate, pH 7.5 and Eluent B (50 mM Tris-HCl+500 mM sodium perchlorate+1 mM ethylenediamine tetraacetic acid, disodium salt, dihydrate, pH 7.5).

The gradient was adjusted with time as follows: 0-3 min: 19% B; 3-6 min: 24.5% B; 6-9.5 min: 60% B; 9.5-13 min: 100% B; 13-15 min: 8% B; 15-19 min: 19% B at a flow rate of 0.5 mL/min. 5 μl of diluted serum (diluted 1 to 5 in PBS) was injected onto the column.

The column eluent was led to the FLLEX as described for Example 1 and combined with a flow of 0.5 mL/min of CCl₃H:MeOH (2:1). The FLLEX was set at a pressure of 4 bar and a differential pressure of 200 mbar. The organic phase was mixed with 0.5 mL/min IPA/MeOH (2:1) and 7.5 mM ammonium acetate, which was led to the electrospray source of an LTQ Velos Elite mass spectrometer.

The anion-exchange chromatography on a diethylaminoethyl-ligand column works by separating analytes (in this example, lipoproteins) based on their ionic interaction with the column material. Consequently, it was found that the elution order of the lipoproteins was different to the order eluted using the size exclusion chromatography column used in Example 1, which works by eluting the biggest particle first. The sample used was commercial human serum, and was found to contain mainly HDL and LDL. (It was thought that VLDL had been decomposed during freeze-thaw cycles not related to the method used here). The method used was based on Hirowatari Y. et al., Journal of Lipid Research 2003,44:1404-1412.

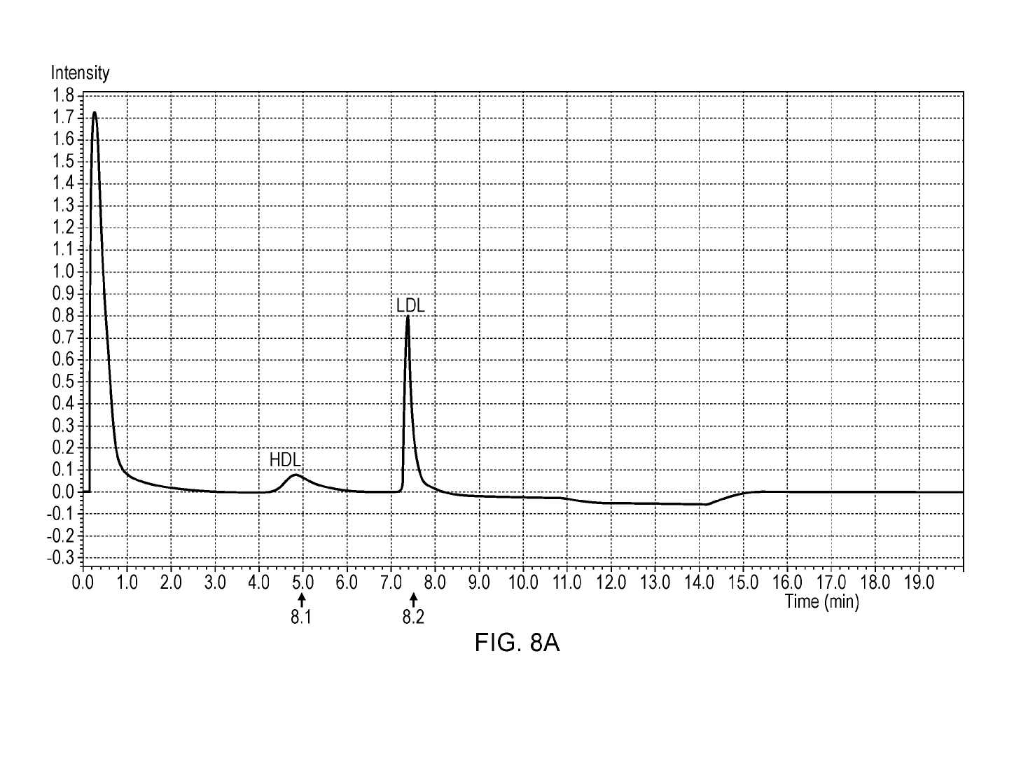

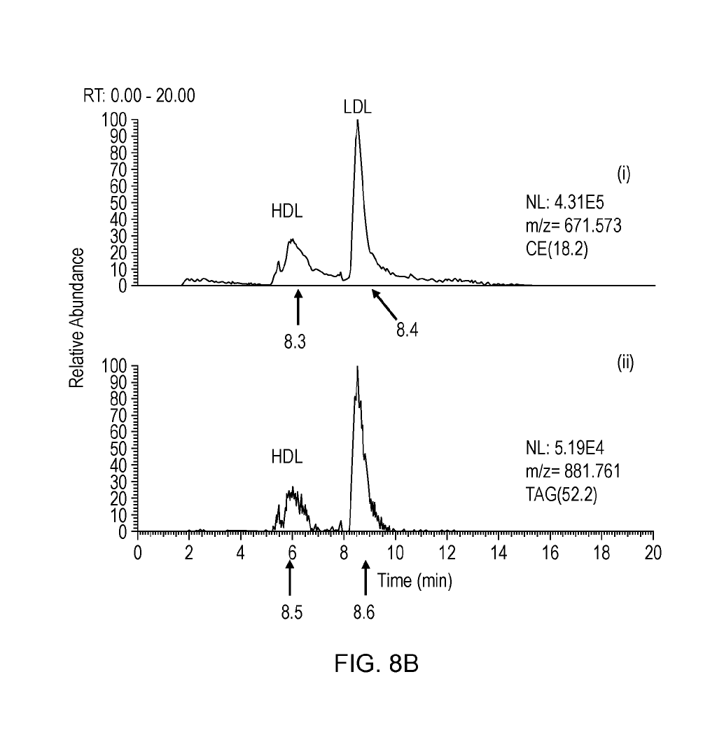

Accordingly, it was shown that the method of the invention can be applied when separating the lipoprotein particles by anion exchange chromatography and through the use of the FLLEX the lipid composition of the particles could be observed (see FIG. 8).

FIG. 8 (a) is a UV chromatogram (230 nm), which shows a small peak 8.1 for HDL (peak maximum at around 5 min) and a more intense peak 8.2 for LDL (peak maximum at around 7.5 min).

FIG. 8 (b) shows MS chromatograms of the HDL 8.3, 8.5 and LDL 8.4, 8.6. The HDL peak 8.3, 8.5 is broader with lower relative abundance than the LDL peak 8.4, 8.6, and occurred earlier (peak maximum around 6 min) than the LDL peak 8.4, 8.6 (peak maximum around 8.75 min). This is the case for both sodiated ions of linoleate cholesterol ester (CE(18:2) (i) and a triglyceride (TAG(52:2) (ii).

### EXAMPLE 3

### Polymers

It may be of interest to separate and/or analyse polymers from a mixture of polymers. Proteins are an example of biological polymer. Exemplified herein is an example of non-biological polymer, polyethylene glycol (PEG). The polymer may have a molecular weight in the range 100-500,000 g/mol, for example between 1,000-450,000 g/mol, for example around 1,400 g/mol, around 27,000 g/mol, around 450,000 g/mol. As will be understood by the skilled person, the invention may be applied to a number of different sorts of polymer having particular properties and chemical functionalities other than those specifically mentioned here.

A commercial set of polyethyleneglycol (PEG) polymers of different weights (Agilent EasiVial PEG (PL20700201)) was used in combination with different size exclusion chromatography columns. The mixture contained three polymers with molecular weights of 440,600, 26,990 and 1,410 g/mol. This mixture was used at concentration of 1 mg/mL and 5 μl was injected onto the separation apparatus.

The first analysis of the polymers was done with a Phenomenex Yarra column (4.6 mm ID×300 mm) with 3 μm Yarra 4000 particles with 500 Å pores. The same instrumental set-up was used as above, with the exception that the mass spectrometer was an Advion CMS (single quadrupole mass spectrometer). The column solvent was an aqueous buffer (0.05 mM Na₂HPO₄, 0.05 mM NaH₂PO₄, 0.15 mM NaCl, pH 6.78) at an isocratic flow of 0.75 mL/min. The organic phase was 0.75 mL/min of CCl₃H:MeOH (2:1). The FLLEX was set at a pressure of 4 bar and differential pressure of 200 mbar.

After the phase separation by the FLLEX, 0.2 mL/min of acetonitrile with 0.1% of formic acid was added to enhance ionisation and spray stability in the analysis apparatus.

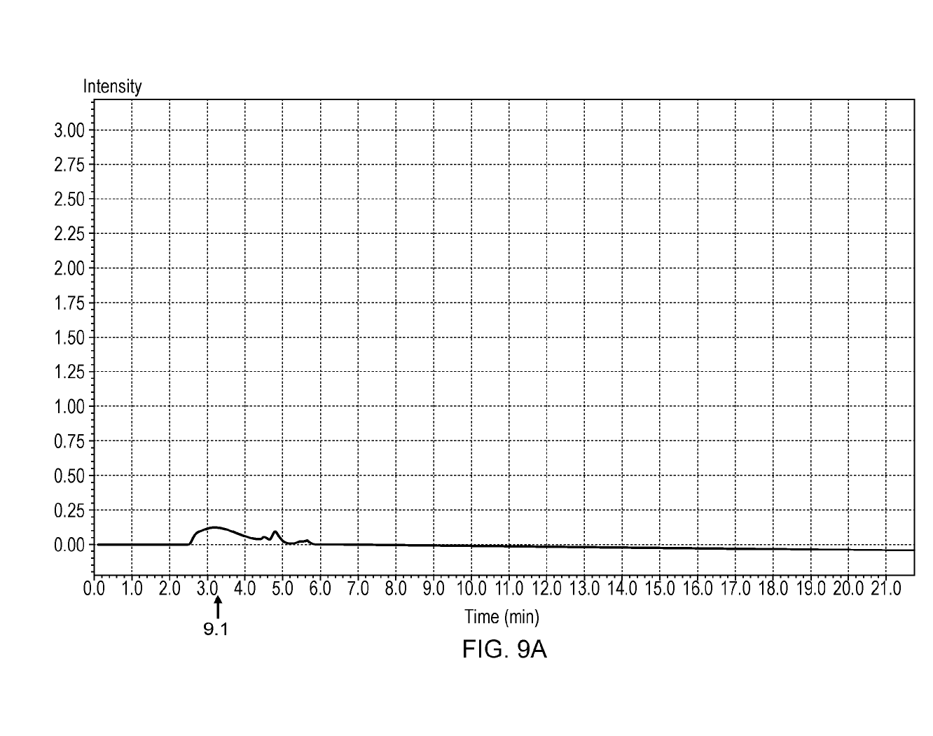

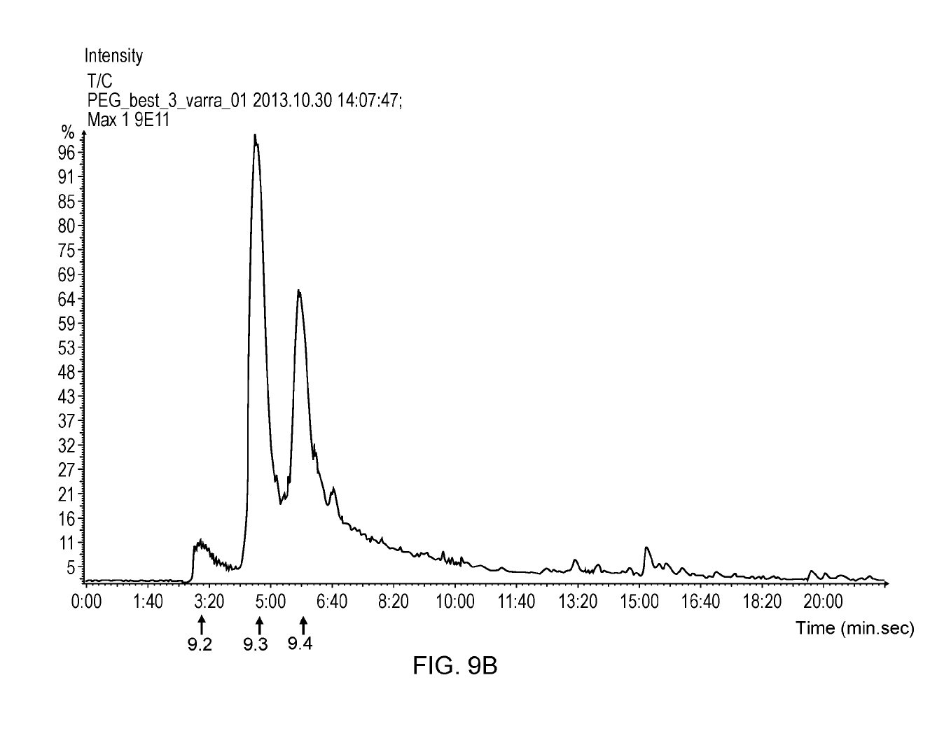

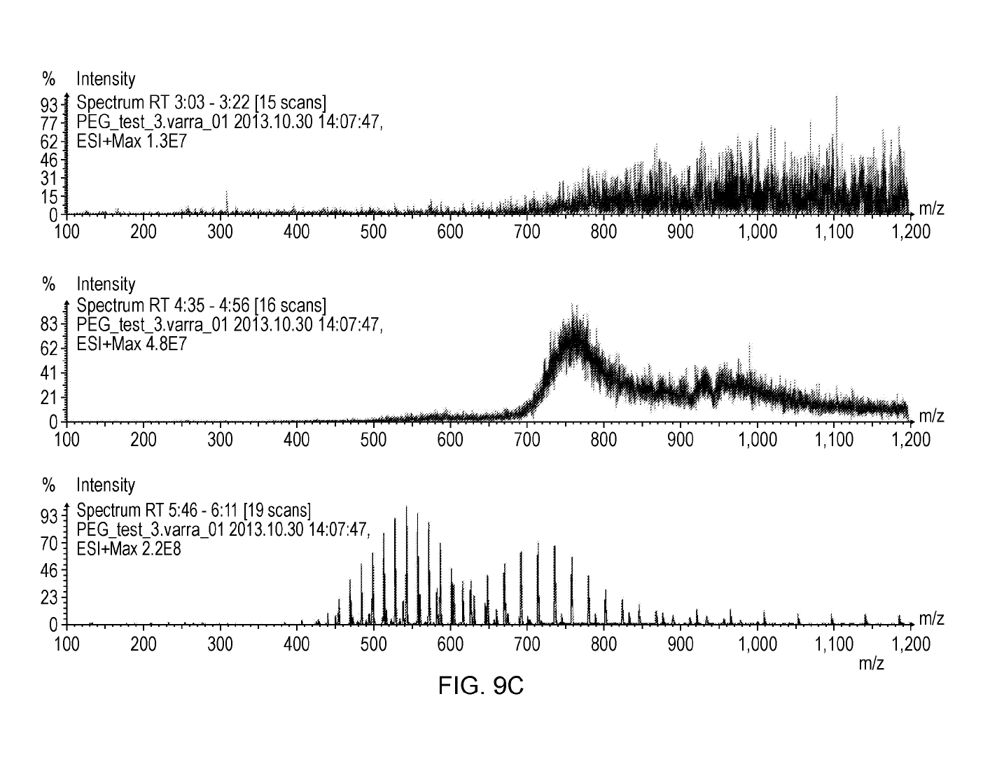

The PEGs did not absorb UV light and therefore the UV chromatogram did not reveal the different polymers (see FIG. 9 (a)). As shown in FIG. 9 (a), a low intensity broad peak 9.1 was observed at between around 2.5 min to 5.75 min. Accordingly, information about the polymer analytes could not be ascribed.

However the MS showed clearly the three different polymers (see FIG. 9 (b) and (c)). The total ion current (TIC) shown in FIG. 9 (b) displayed three well resolved peaks, one 9.2. of low relative intensity at around 3 mins, one 9.3 at the highest relative intensity at around 4.4 mins, and one 9.4 at around 5.75 mins. FIG. 9 (c) shows that at 3 mins the three polymers could not be resolved by MS, while by 4.4 mins some MS peaks could be observed, and at 5.75 mins the MS peaks were well resolved. Although the aim with polymers was to produce a single polymer, there is usually some variation in chain length in the original sample. The average molecular weight of the smallest polymer was 1,410 g/mol. The mass spectra showed the doubly- and triply charged ions of the polymers. The main triply charged ions were found at around 513.5 (M+Na+3H+) and the main doubly charged ion was found at around 736.5 (M+2H+). Both showed that the mass of this polymer was 1,471.1 g/mol, which is close to the commercially provided average value. The two other polymers were very big and are measured as multiply charged ions with the different charge envelopes. A high resolution instrument could reveal their masses.

The experiments with PEG standards were also performed using an Agilent aquagel-OH mixed-H column (7.5 mm ID×300 mm). The same solvents were used as with the Yarra column. The flow rate was set at 0.5 mL/min. The organic phase was set to 0.5 mL/min. All other parameters were maintained as for the Yarra column.

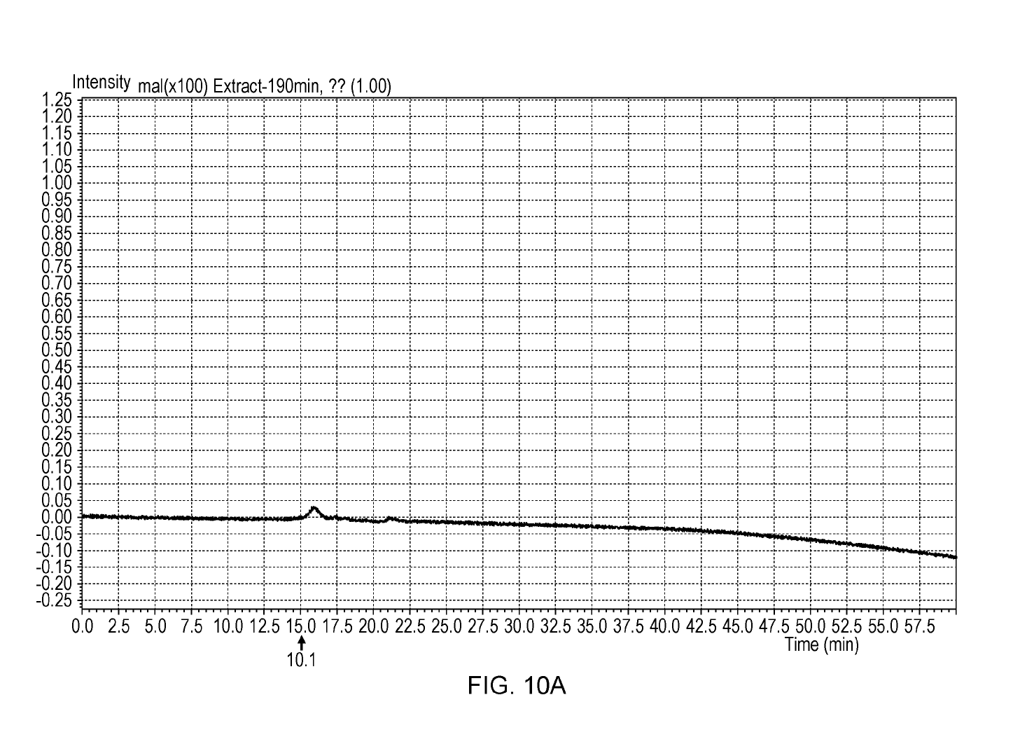

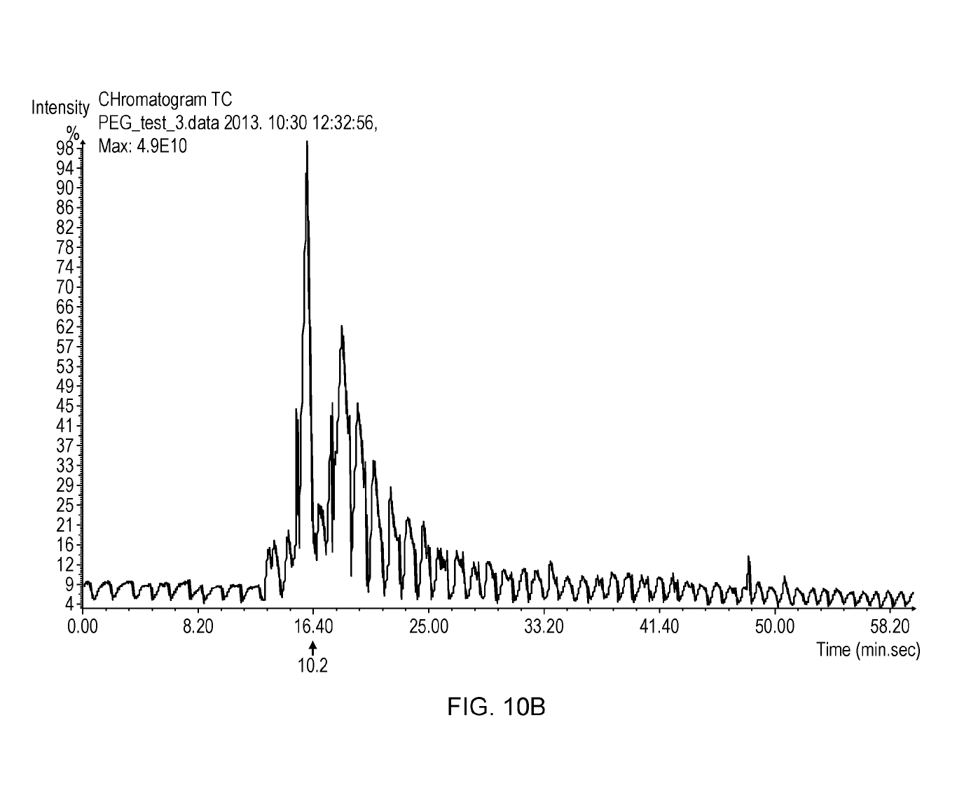

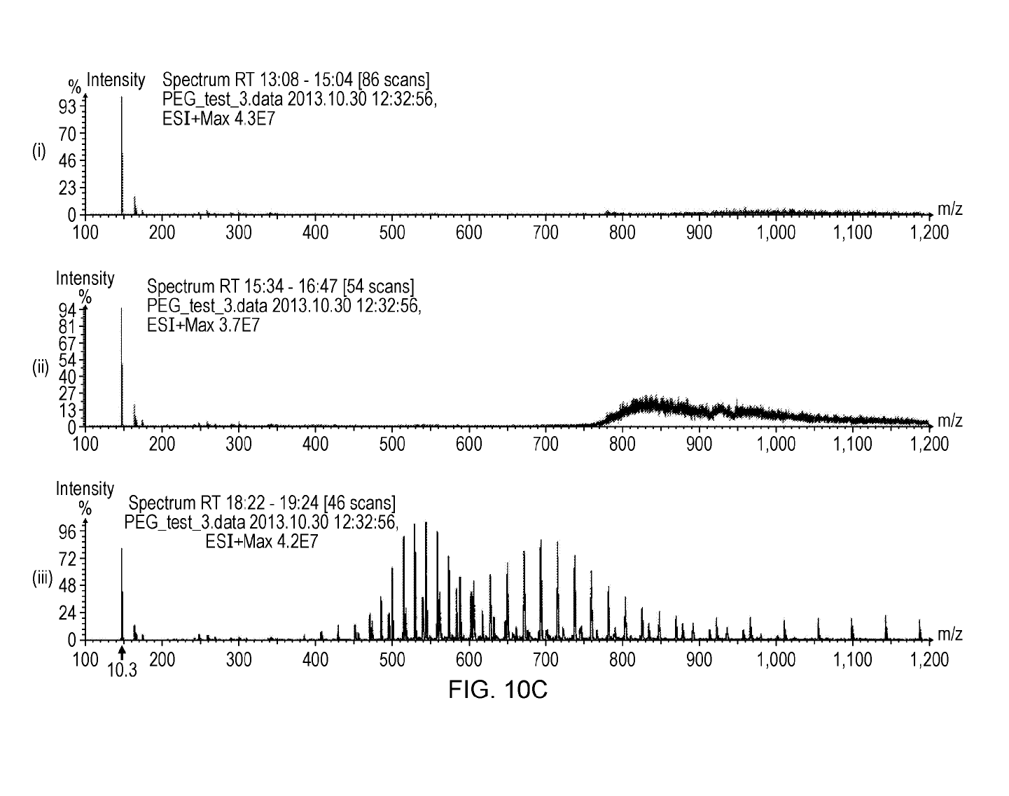

The results (see FIG. 10) are comparable to those obtained with the above-discussed Yarra column, but the retention time was much longer and because the PEGs were spread out more, the UV failed to detect these compounds. In this case, only a very low intensity peak 10.1 at around 15-16 mins was observed in the UV spectrum (see FIG. 10 (a)). The longer retention time can be seen in both the TIC of FIG. 10 (b), in which the peak of maximum intensity 10.2 was not obtained until about 16 min 40 s (compared to around 4.4 mins for the Yarra column), and in the time dependent MS spectra of FIG. 10 (c), where the peaks in spectrum (ii) were less well resolved compared to those of FIG. 9 (c) (ii), and were obtained at 16 mins compared to 4.4 mins for FIG. 9 (c) (ii). The well resolved spectrum of FIG. 10 (c) (iii) was recorded at 18 mins, compared to 5.75 mins for the Yarra column. A contaminant trace 10.3 at 146.2 m/z was also found in the MS spectra in this case (see FIG. 10 (c)). Overall, however, the MS spectra were very similar to those obtained using the above-discussed Yarra column, and had the same charge state envelopes. These experiments showed that purity of the polymers can be determined in much better detail using the system and method of the invention than with other techniques, such as refractive index.

### Other Embodiments

In other embodiments, the analyte may include an antibody. The embodied systems described above can be adapted to separate and analyse an antibody by altering the chromatography column. The activity of antibodies is dependent on their structural formation. This can be checked using SEC. The size of antibodies is usually smaller than lipoproteins, and so many different types of SEC columns are available as understood by the skilled person. The eluents may be flowed through a unit containing trypsin, which may be immobilized. The prepared antibody may then be flowed through the liquid-liquid extraction apparatus as described herein, and hydrophobic peptides partitioned and separated for analysis.

In other embodiments, the analyte may include a peptide. The embodied systems described above can be adapted to separate and analyse a peptide or protein which is hydrophobic or has a hydrophobic region by altering the chromatography column. Upstream digestion of the liquid-liquid extraction apparatus, the proteins or peptides may be suitably digested, for example using immobilized trypsin, in preparation for partitioning and separation prior to analysis.

In other embodiments, the analyte may include a milk lipid. The embodied systems described above can be adapted to separate and analyse a milk globule which could be separated by size exclusion chromatography or ion exchange chromatography and dissociated by the organic phase in the liquid-liquid extraction apparatus described herein. This would allow determination of the lipid composition in a milk globule by size or by ionic interaction.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

All references referred to above are hereby incorporated by reference.

1. An extraction and analysis system comprising a liquid-liquid extraction apparatus and an analysis apparatus, wherein the liquid-liquid extraction apparatus is configured to receive a substantially continuous inlet flow of a first liquid, the first liquid carrying a mixture of components including an analyte, the liquid-liquid extraction apparatus being operable to receive a second liquid for contact with the first liquid, the second liquid being substantially immiscible with the first liquid, in order to partition the analyte and/or another component carried by the first liquid preferentially into the second liquid substantially continuously and to subsequently separate the first and second liquids substantially continuously, the system further comprising an outlet flow conduit operable substantially continuously to conduct the analyte, in a corresponding flow of said first or second liquid, to the analysis apparatus for substantially continuous analysis.

2. The system according to claim 1, wherein the liquid-liquid extraction apparatus comprises a contact region configured and dimensioned to allow the first and second liquids to contact each other in a slug flow regime.

3. The system according to claim 1, wherein the analysis apparatus comprises a sample preparation portion and a sample analysis portion.

4. (canceled)

5. The system according to claim 3, wherein the sample analysis portion comprises a mass spectrometer.

6. The system according to claim 1, comprising a separation apparatus configured to provide the substantially continuous inlet flow of the first liquid.

7. The system according to claim 1, wherein the separation apparatus comprises a chromatography column.

8. The system according to claim 7, wherein the chromatography column is a size-exclusion chromatography column.

9. (canceled)

10. The system according to claim 1, comprising a detector arranged within the system upstream of the liquid-liquid extraction apparatus.

11. (canceled)

12. The system according to claim 1, wherein the analyte includes one or more of a lipid, protein, antibody, peptide and polymer.

13-19. (canceled)

20. A separation and extraction system comprising a separation apparatus and a liquid-liquid extraction apparatus, wherein the separation apparatus is configured to receive an input mixture including an analyte, the separation apparatus being capable of substantially separating the analyte in the input mixture, the separation apparatus being configured to provide a substantially continuous outlet flow of first liquid, the first liquid carrying a mixture of components including the analyte, the system further comprising a flow conduit operable substantially continuously to conduct the first liquid carrying the analyte to the liquid-liquid extraction apparatus, wherein the liquid-liquid extraction apparatus is configured to receive the substantially continuous outlet flow of first liquid from the separation apparatus, the liquid-liquid extraction apparatus being operable to receive a second liquid for contact with the first liquid, the second liquid being substantially immiscible with the first liquid, in order to partition the analyte and/or another component carried by the first liquid preferentially into the second liquid substantially continuously and to subsequently separate the first and second liquids substantially continuously.

21. The system according to claim 20, wherein the separation apparatus comprises a chromatography column.

22. The system according to claim 21, wherein the chromatography column is a size-exclusion chromatography column.

23. (canceled)

24. The system according to claim 20, comprising a detector arranged within the system between the separation apparatus the liquid-liquid extraction apparatus.

25. (canceled)

26. The system according to claim 20, wherein the analyte includes one or more of a lipid, protein, antibody, peptide and polymer.

27. (canceled)

28. A method of separating and extracting an analyte from a mixture including the analyte, the method comprising the steps:
inputting an input mixture including an analyte into a separation apparatus, substantially separating the analyte in the input mixture to provide a substantially continuous flow of first liquid from the separation apparatus, the first liquid carrying a mixture of components including the analyte;
substantially continuously conducting the flow of first liquid to a liquid-liquid extraction apparatus;
providing the liquid-liquid extraction apparatus with a second liquid which is substantially immiscible with the first liquid, contacting the first and second liquids, allowing the analyte and/or other component carried by the first liquid to preferentially partition into the second liquid substantially continuously; and, subsequently,
separating the first liquid and second liquid substantially continuously, to provide the analyte in a corresponding substantially continuous outlet flow of said first or second liquid.

29. The method according to claim 28, wherein in the liquid-liquid extraction apparatus the first and second liquids to contact each other in a slug flow regime.

30. The method according to claim 28, comprising detecting a property of the flow of the first liquid between the separation apparatus and the liquid-liquid extraction apparatus.

31. The method according to claim 28, further comprising the steps:
substantially continuously conducting the analyte, in said corresponding outlet flow of said first or second liquid, to an analysis apparatus; and
substantially continuously analysing a property of the analyte in the flow over time.
